(19) United States
(12) Patent Application Publication
(10) Pub. No.: US 2025/0060990 A1
(43) Pub. Date: Feb. 20, 2025

(54) METHOD, ELECTRONIC DEVICE, AND COMPUTER PROGRAM PRODUCT FOR PROCESSING WORKLOADS

(71) Applicant: DELL PRODUCTS L.P., Round Rock, TX (US)

(72) Inventors: Ran LIU, Beijing (CN); Tao CHEN, Beijing (CN); Wei LU, Beijing (CN)

(21) Appl. No.: 18/372,501

(22) Filed: Sep. 25, 2023

(30) Foreign Application Priority Data
Aug. 18, 2023 (CN) 202311049751.8

(51) Int. Cl. G06F 9/48

(52) U.S. Cl. CPC G06F 9/4881

(57) ABSTRACT

Embodiments of the present disclosure relate to a method, an electronic device, and a computer program product for processing workloads. The method includes determining a priority threshold for a task queue based on queue data of the task queue. The method further includes acquiring a priority of a workload at the queue head of the task queue. The method further includes processing the workload by using a processor in response to the priority being greater than the priority threshold. In addition, the method further includes processing the workload without using the processor in response to the priority being less than or equal to the priority threshold. Through the solution in the embodiments of the present disclosure, the priority threshold can be dynamically adjusted to prioritize high-priority loads by utilizing the processor when processor resources are insufficient, thereby ensuring that the high-priority workloads are prioritized for processing.

### TECHNICAL FIELD

Embodiments of the present disclosure relate generally to the field of computers, and more specifically to a method, an electronic device, and a computer program product for processing workloads.

### BACKGROUND

A persistent memory (PMEM) is a new storage technology that utilizes non-volatile memory media to achieve data persistence storage. Compared with conventional disks and solid-state drives, a PMEM has faster read and write speeds and higher durability, which can accelerate data access and processing. It has broad application prospects in fields such as data centers, high-performance computing, and embedded systems, and is expected to bring revolutionary changes to storage technologies.

PMEM is a trend device in a storage system. Under current technologies, accessing a PMEM requires a processor (processor) instruction, which means that processor resources may become a performance bottleneck under heavy loads. Therefore, how to better utilize processor resources for high-priority workloads under heavy loads is crucial for optimizing workload processing.

### SUMMARY OF THE INVENTION

The embodiments of the present disclosure provide a method, a device, and a computer program product for processing workloads.

In a first aspect of the present disclosure, a method for processing workloads is provided. The method includes determining a priority threshold for a task queue based on queue data of the task queue. The method further includes acquiring a priority of a workload at the queue head of the task queue. The method further includes processing the workload by using a processor in response to the priority being greater than the priority threshold. In addition, the method further includes processing the workload without using the processor in response to the priority being less than or equal to the priority threshold.

In another aspect of the present disclosure, an electronic device is provided. The device includes a processing unit and a memory, wherein the memory is coupled to the processing unit and stores instructions. The instructions, when executed by the processing unit, perform the following actions: determining a priority threshold for a task queue based on queue data of the task queue; acquiring a priority of a workload at the queue head of the task queue; processing the workload by using a processor in response to the priority being greater than the priority threshold; and processing the workload without using the processor in response to the priority being less than or equal to the priority threshold.

In still another aspect of the present disclosure, a computer program product is provided. The computer program product is tangibly stored on a non-transitory computer-readable medium and contains computer-executable instructions. The computer-executable instructions, when executed, cause a computer to perform the method or process according to the embodiments of the present disclosure.

The Summary of the Invention part is provided to introduce the selection of concepts in a simplified form, which will be further described in the Detailed Description below. The Summary of the Invention part is neither intended to identify key features or essential features of the present disclosure, nor intended to limit the scope of the embodiments of the present disclosure.

### BRIEF DESCRIPTION OF THE DRAWINGS

By description of example embodiments of the present disclosure in more detail with reference to the accompanying drawings, the above and other objectives, features, and advantages of the present disclosure will become more apparent. In the example embodiments of the present disclosure, the same reference numerals generally represent the same elements.

FIG. 1 shows a schematic diagram of an example environment in which embodiments of the present disclosure can be implemented;

FIG. 2 shows a flow chart of a method for processing workloads according to some embodiments of the present disclosure;

FIG. 3 shows a schematic diagram of a system for processing workloads according to some embodiments of the present disclosure;

FIG. 4A shows a schematic diagram of a process of inserting a workload into a task queue according to some embodiments of the present disclosure;

FIG. 4B shows a schematic diagram of a process of adjusting a workload in a task queue according to some embodiments of the present disclosure;

FIG. 4C shows a schematic diagram of a process of inserting a workload into a task queue according to some embodiments of the present disclosure;

FIG. 5 shows a flow chart of a method for managing a workload in a task queue according to some embodiments of the present disclosure;

FIG. 6 shows a flow chart of a method for processing workloads according to some embodiments of the present disclosure; and

FIG. 7 shows a schematic block diagram of a device that can be used to implement embodiments of the present disclosure.

### DETAILED DESCRIPTION

Preferred embodiments of the present disclosure will be described in more detail below with reference to the accompanying drawings. While some specific embodiments of the present disclosure are shown in the accompanying drawings, it should be understood that the present disclosure may be implemented in various forms, and should not be limited to the embodiments set forth herein. Rather, these embodiments are provided to make the present disclosure more thorough and complete and to fully convey the scope of the present disclosure to those skilled in the art.

The term “include” and variants thereof used in this text indicate open-ended inclusion, that is, “including but not limited to.” Unless specifically stated, the term “or” means “and/or.” The term “based on” means “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects, unless otherwise specifically indicated.

When processing workloads in a computing device, high-priority workloads cannot be processed in time due to a low processing efficiency when processor resources are insufficient, which affects the system performance. In existing solutions, a constant static priority threshold is usually set. When the priority of a workload is greater than the static priority threshold, the processor (CPU) is used to process the workload. When the priority of the workload is less than the static priority threshold, the processor is not used (CPU-less) to process the workload. The static priority may have some drawbacks, for example, when processing resources are severely insufficient, all workloads with priorities greater than the static priority threshold are still processed utilizing the processor, but those greater than the static priority threshold may have a plurality of different priorities, wherein low-priority workloads may still occupy the processor resources for high-priority workloads. In addition, when the processor resources are sufficient, some low-priority workloads may also be processed by using the processor. However, due to the static priority threshold, these workloads still cannot be processed by using the processor, which affects the processing efficiency of the system. In summary, the static priority threshold cannot be adjusted in time based on the usage of processor resources, which affects the processing of high-priority workloads and also affects the overall processing efficiency of the system.

Therefore, the embodiments of the present disclosure propose a method for processing workloads, which uses queue data of a task queue to determine current usage of processor resources and achieve dynamic adjustment of a priority threshold. The dynamic priority threshold can be adjusted in time based on the usage of processor resources, so that when processor resources are insufficient, the high-priority loads can be prioritized for processing by using the processor and the low-priority loads are processed without using the processor, thereby ensuring that high-priority workloads can be prioritized for processing. In addition, due to the use of the dynamic priority threshold, whether to use the processor to process a workload depends not only on the priority of the workload itself, but also on the magnitude relationship between the priority and the dynamic priority threshold, so as to dynamically and adaptively allocate the processor to process different types of workloads based on system resources, thereby improving the processing efficiency of the system.

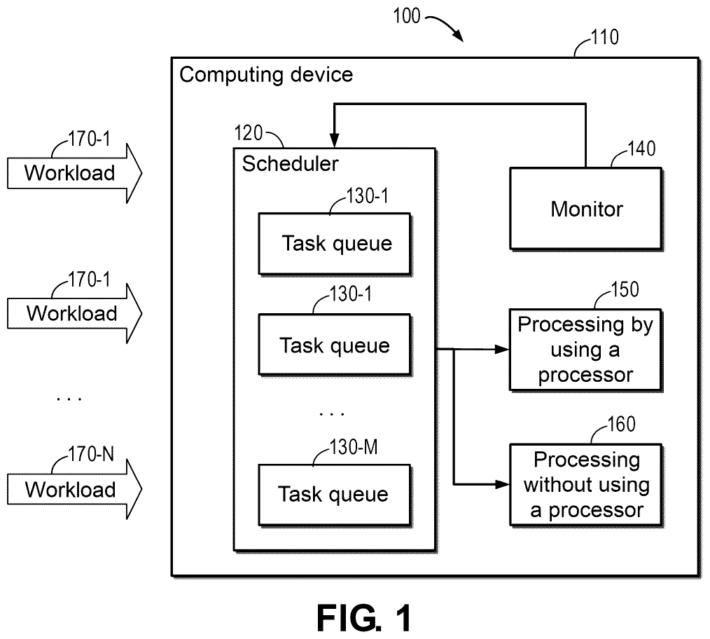

FIG. 1 illustrates a schematic diagram of an example environment 100 in which embodiments of the present disclosure can be implemented. As shown in FIG. 1, the example environment 100 includes a computing device 110. Examples of the computing device 110 include, but are not limited to, a personal computer, a handheld device (such as a smartphone and a tablet), a server, a workstation, an embedded system, a cloud computing device, a supercomputer, a game console, an Internet of Things (IoT) device, an embedded controller, and the like. In the computing device 110, processing different types of workloads (such as workloads 170-1 to 170-N, wherein N is the number of workloads) often relies on the processor. For example, when tasks that workloads access a PMEM are processed, the processor is required for processing, and different workloads have different priorities. Therefore, it is necessary to dynamically process different types of workloads by determining their priorities. When processor resources are insufficient, low-priority workloads are processed without using the processor, thereby ensuring that high-priority workloads can be prioritized for processing.

The example environment 100 further includes a scheduler 120, and the scheduler 120 can dynamically adjust the manner of processing different types of workloads based on the current load situation of the processor. For example, the scheduler 120 may acquire from a monitor 140 the current usage of the processor, including but not limited to processor usage, task queue length, load waiting time, and the like, for determining the load situation of the processor. The scheduler 120 includes a task queue 130-1, a task queue 130-2, . . . , and a task queue 130-M (individually or collectively referred to as a task queue 130), wherein M is the actual number of task queues, and its range varies according to the processing capacity of the computing device 110, which is not limited herein. For example, when the processor resources are insufficient and a workload exits the queue from the task queue 130, the scheduler may determine, according to the priority of the workload and the priority threshold, to process the workload through the processor processing 150, or process the workload without using the processor processing 160.

Processing the workload through the processor may be that, for example, a storage application may access a persistent memory (PMEM) in a Direct Access (DAX) mode. In the DAX mode, an input/output (IO) operation does not need to switch from a kernel mode to a user mode, but still needs to perform CPU copy operations. It should be noted that the CPU copy operation here uses a MOVNT instruction without going through a CPU cache. In theory, pmem_memcpy is faster than memcpy, but the method still requires participation of the CPU. Because the processor can process the workload fast, when the processor resources are insufficient, processing the workload through the processor can ensure that high-priority workloads are processed quickly, thereby improving the processing efficiency of the computing device 110.

Processing workloads without using the processor may use, for example, some IO technologies that do not require a processor, and some examples are described as follows. For example, Remote Direct Memory Access (RDMA-loopback) is a PMEM access method that utilizes a host channel adapter supporting RDMA and does not involve participation of the processor. In other words, the RDMA loopback may provide an acceptable performance as a data transmitter. However, compared with using a processor, there may be a certain amount of latency. Data Streaming Accelerator (DSA) is a technology that optimizes data transmission between different components within a computer system, such as a processor, a memory, and a storage device. It provides a hardware-based solution to move data more efficiently, thereby reducing the latency and improving performance. DSA enables the processor to delegate a data transmission task to a specialized engine, thereby releasing the processor to focus on other tasks. An I/O Acceleration Technology (I/OAT) DMA is a technology that accelerates data transmission between a server I/O subsystem and a memory. It unloads the data transmission process from the processor to a dedicated DMA engine, thereby releasing the processor to perform other tasks. The I/OAT DMA engine provides optimized memory-to-memory and I/O-to-memory data transmission, thereby reducing the latency and increasing the throughput. The technology is particularly useful in data-intensive applications such as database management, virtualization, and content delivery networks.

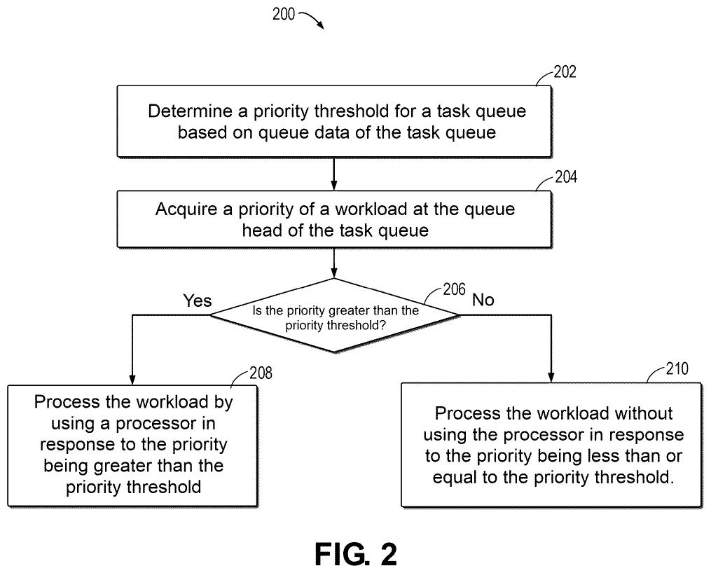

FIG. 2 shows a flow chart of a method 200 for processing workloads according to some embodiments of the present disclosure. At 202, a priority threshold for a task queue is determined based on queue data of the task queue. In some embodiments, in order to dynamically adjust a processor to process workloads in the task queue, a dynamically changing priority threshold is used. For example, the priority threshold for the task queue is determined based on the queue data of the task queue. When the queue data reflects that current processor resources are insufficient, the priority threshold may be raised. When the queue data reflects that the current processor resources are sufficient, the priority threshold may be lowered. The priority threshold may be determined in different forms by utilizing the queue data of the task queue, for example, determined through rule judgment, determined through a machine learning model, determined through a user configuration, or determined in any other manner, which is not limited in the present disclosure.

At 204, a priority of a workload at the queue head of the task queue is acquired. For example, when a workload at the queue head of the current task queue needs to be processed, the priority of the workload needs to be acquired. In some embodiments, the priority of the workload is directly acquired from the workload, and the priority of the workload may also be acquired from another module. In addition, the priority of the workload may be configured based on conventional priority data, which may be configured by a user based on his/her actual business, for improving the processing efficiency of the actual business. After the priority of the workload at the queue head is acquired, the priority may be compared with the priority threshold determined at 202 to determine a processing method for the workload.

At 206, whether the priority of the workload at the queue head of the task queue is greater than the priority threshold is determined. At 208, the workload is processed by using the processor in response to the priority being greater than the priority threshold. For example, the priority of the workload at the queue head may be compared with the priority threshold, and when the priority is greater than the priority threshold, the workload is processed by using the processor. The priority being greater than the priority threshold means that the workload is a high-priority workload, and therefore, using the processor can quickly process the workload, thereby ensuring that the high-priority load is processed quickly. It should be understood that the priority threshold may dynamically change based on the queue data and the usage of the processor, and therefore, the magnitude relationship between a certain workload (with a fixed priority) and the priority threshold may also change accordingly.

At 210, the workload is processed without using the processor in response to the priority being less than or equal to the priority threshold. For example, for example, the priority of the workload at the queue head may be compared with the priority threshold, and when the priority is less than or equal to the priority threshold, the workload may be processed without using the processor. The priority being less than or equal to the priority threshold means that the workload is a low-priority workload, and therefore, the workload is processed without using the processor. Not using the processor may slow down the speed of processing the workload; however, it can save processor resources for processing high-priority loads, thereby ensuring that high-priority loads are processed quickly. It should be understood that the priority threshold will dynamically change based on the queue data and the usage of the processor, and therefore, the workload may also be processed by using the processor when the processor resources are sufficient.

Therefore, the solution for processing workloads according to the embodiments of the present disclosure may determine, by comparing the priority of the workload with the dynamically changing priority threshold, whether to use the processor to process the workload. Therefore, processing high-priority workloads by utilizing the processing and processing low-priority loads without using the processor are implemented, thereby ensuring that high-priority loads can be prioritized and that the priority threshold can be dynamically adjusted to improve the processing efficiency of the system.

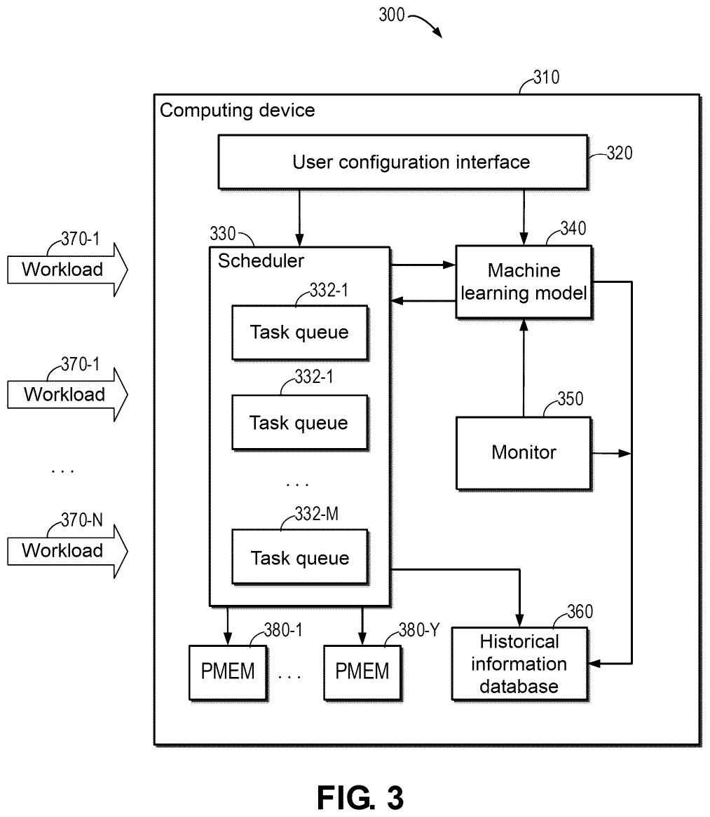

FIG. 3 shows a schematic diagram of a system 300 for processing workloads according to some embodiments of the present disclosure. As shown in FIG. 3, the system 300 includes a computing device 310, and examples of the computing device 310 include but are not limited to a personal computer, a handheld device (such as a smartphone and a tablet), a server, a workstation, an embedded system, a cloud computing device, a supercomputer, a game console, an Internet of Things (IoT) device, and an embedded controller. The computing device 310 includes a user configuration interface 320, and the user configuration interface 320 may allow a user to configure the priority of each workload. For example, according to different actual businesses of the user, the priorities of workloads may also change, and therefore, the user needs to configure priorities of different workloads according to actual situations. In addition, the user may also adjust priorities of different workloads according to actual situations, thereby improving the processing efficiency of the system. In addition, the user configuration interface 320 may also allow the user to configure a machine learning model 340 and a task queue 332. For example, in some embodiments, the user may use the user configuration interface 320 to select different machine learning models, or configure the number and the length of the task queues 332.

As shown in FIG. 3, the system 300 further includes a scheduler 330, and the scheduler 330 is responsible for scheduling the task queue 332. The scheduler 330 may process workloads based on a priority threshold, and the priority threshold may be determined by the machine learning model 340 and a monitor 350. For example, in some embodiments, the monitor 350 may acquire queue data information of the current task queue, including but not limited to task queue length, workload priority distribution, workload group size, response time distribution, and the like. In addition, the monitor 350 may provide the queue data to the machine learning model 340, and the machine learning model 340 calculates the current priority threshold by utilizing the queue data. It is understandable that the queue data is real-time data acquired when calculating the priority threshold, and therefore, the priority threshold may change according to the queue data. The queue data also reflects the usage of the processor. Therefore, when the processor resources are insufficient, the priority threshold may be relatively high, and when the processor resources are sufficient, the priority threshold may be relatively small.

In addition, the scheduler 330 may also write the queue data of the task queue 332 to a historical information database 360 to save the queue data. In this way, the machine learning model 340 may be regularly trained by utilizing the historical information database 360 and labeled data of the priority threshold, for achieving iteration of the machine learning model 340. The machine learning model 340 may include but is not limited to a linear regression model, a logistic regression model, a decision tree model, a random forest model, a support vector machine (SVM), a K-nearest neighbor (KNN) model, a neural network model, and the like, which is not limited in the present disclosure.

When workloads 370-1 to 370-N (collectively or individually referred to as the workload 370) enter the computing device 310, the workload 370 is first inserted into work queues 332-1 to 332-M (collectively or individually referred to as the work queue 332) through polling. In some embodiments, when a workload requires access to a persistent memory (PMEM) 380, the scheduler 330 may compare a priority of the workload with a priority threshold. When the priority of the workload is greater than the priority threshold, the PMEM is accessed by using the processor. When the priority of the workload is less than or equal to the priority threshold, the PMEM is accessed without using the processor. The priority threshold is dynamically changed and the manners for different workloads to access the PMEM are also dynamically changed, and therefore, when processor resources are insufficient, high-priority workloads are prioritized by using the processor resources. When the processor resources are sufficient, low-priority workloads may also be processed by using the processor resources, thereby improving the processing efficiency of the system 300.

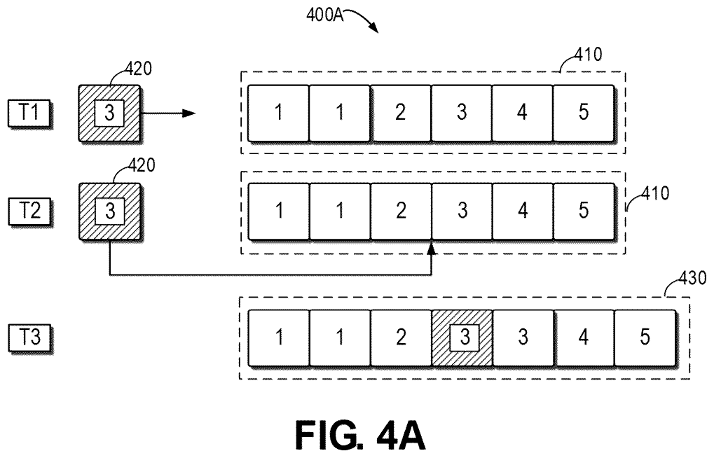

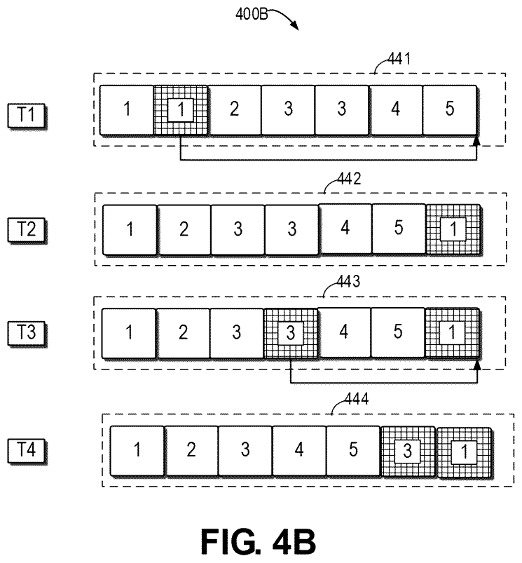

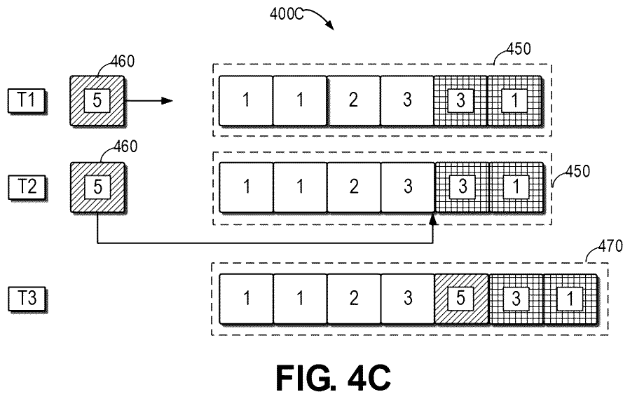

FIG. 4A shows a schematic diagram of a process 400A of inserting a workload into a task queue according to some embodiments of the present disclosure. As shown in the process 400A, at time T1, there are 6 workloads in a task queue 410, that is, the queue length is 6. The queue length being 6 here is only an example for illustration, and a queue length of another number may also be used. The priority of each workload in the task queue is listed. For example, the priority of the workload at the queue head is 5, and the priority of the workload at the queue end is 1. When a workload 420 intends to enter the queue 410, it is first necessary to determine a position for insertion of the workload 420. At T2, by comparing the priority of the workload 420 with priorities of the workloads in the task queue 410, it is determined to insert the workload 420 behind the third workload (as indicated by the arrow). It is understandable that the insertion position is selected according to the priority of the workload. At time T3, the workload 420 is inserted into the selected position to obtain the task queue 430 after the insertion.

FIG. 4B shows a schematic diagram of a process 400B of adjusting a workload in a task queue according to some embodiments of the present disclosure. In the process 400B, a workload covered by grid shadow indicates that a time slice for the workload is about to run out, that is, the time allocated to the workload is about to run out, and therefore, it is necessary to execute the workload as soon as possible. As shown in the process 400B, at time T1, the time slice for the sixth workload in a task queue 441 is about to run out. For example, the time slice for the workload may be compared with a time slice threshold to determine whether the time slice for the workload is about to run out. At time T2, the workload is moved to the queue head, regardless of the priority, for processing, as quickly as possible, the workload whose time slice is about to run out to obtain a task queue 442. At time T3, it is determined that the time slice for the fourth workload of a task queue 443 is about to run out, and therefore, the workload needs to be moved. At time T4, based on ranking of remaining time slices, a workload with a fewer remaining time slice ranks higher. Therefore, the workload is moved to the second position of a task queue 444.

FIG. 4C shows a schematic diagram of a process 400C of inserting a workload into a task queue according to some embodiments of the present disclosure. Compared with the process 400A shown in FIG. 4A, the process 400C considers the time slice factor when inserting a workload. As shown in FIG. 4C, a workload covered by slashes represents a workload to be inserted, and a workload covered by grids represents a workload whose time slice is about to run out. At time T1, time slices for the first workload and the second workload in a task queue 450 are about to run out, and a workload 460 is the workload to be inserted. At time T2, when determining a position for inserting the workload 460, the time slice factor needs to be considered first. The newly inserted workload must be after the workloads whose time slices are about to run out, for ensuring that the workloads whose time slices are about to run out may be prioritized for execution. Secondly, the priority factor of the workloads is then considered. The priority of the workload 460 is 5, which is greater than that of the remaining workloads in the task queue 450, and therefore, it may be determined that the workload 460 needs to be inserted into the third position of the task queue 450. At time T3, the workload 460 is inserted into the third position of the task queue 450 to obtain a new task queue 470.

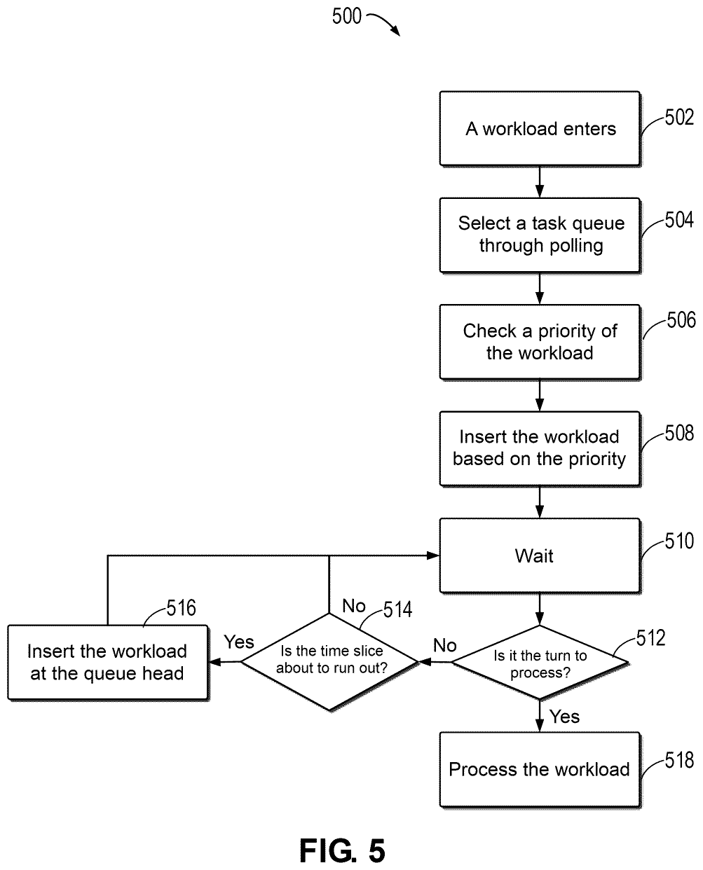

FIG. 5 shows a flow chart of a method 500 for managing a workload in a task queue according to some embodiments of the present disclosure. At 502, a workload enters. For example, in some embodiments, the workload is loaded into a memory in preparation for execution. At 504, a task queue is selected through polling. For example, there are a plurality of task queues in a scheduler, a task queue is selected from the plurality of task queues through polling, and then the workload is inserted into the selected task queue. At 506, the priority of the workload is checked to determine a position for insertion of the workload in the task queue. In some embodiments, it is also necessary to consider the factor of time slices of workloads in a task queue to determine the position for insertion of a workload in the task queue. At 508, the workload is inserted based on the priority. For example, in some embodiments, a high-priority workload is inserted in front of a low-priority workload so that the high-priority workload may be processed as soon as possible. In some embodiments, when a workload whose time slice is about to run out exists in the task queue, all newly inserted workloads need to be inserted behind the workload whose time slice is about to run out.

At 510, the workload in the task queue waits for an instruction from the scheduler, and at 512, it is determined whether it is the turn to process the workload at the queue head of the task queue. When the determination is “Yes,” the procedure proceeds to 518 to process the workload. Otherwise, the procedure proceeds to 514 to determine whether a workload whose time slice is about to run out exists in the queue. In some embodiments, the time slice for a workload may be compared with a time slice threshold for determination. If the determination is “No,” the procedure returns to 510 and continues to wait. Otherwise, the procedure proceeds to 516 to insert the workload whose time slice is about to run out at the queue head of the task queue to prioritize the workload whose time slice is about to run out.

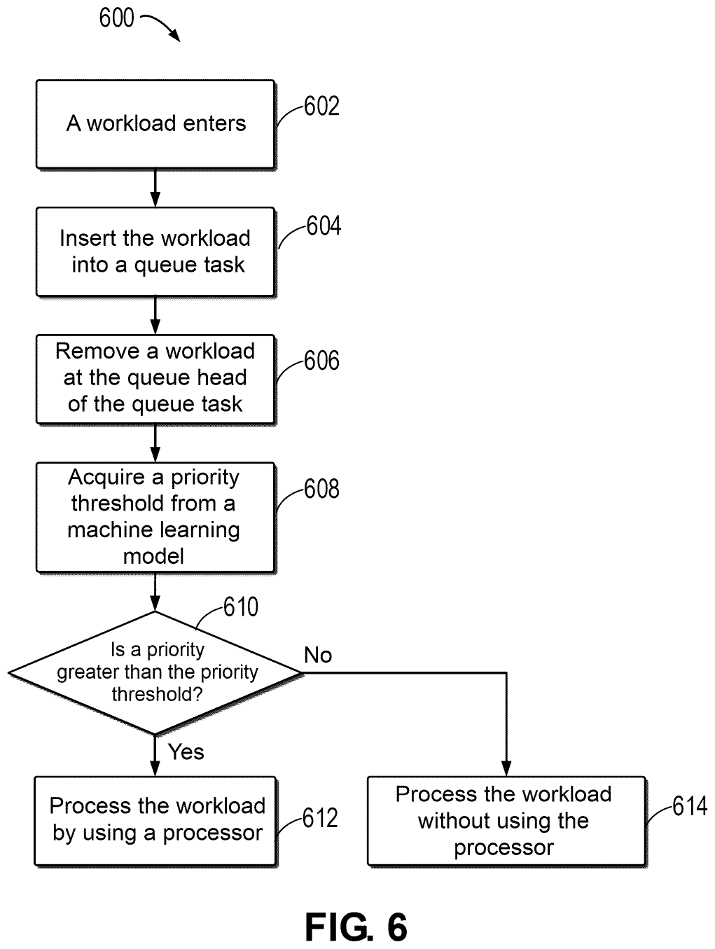

FIG. 6 shows a flow chart of a method 600 for processing workloads according to some embodiments of the present disclosure. As shown in the method 600, at 602, a workload enters. For example, in some embodiments, the workload is loaded into a memory in preparation for execution. At 604, the workload is inserted into a task queue. For example, in some embodiments, the workload is inserted into a specific position in the task queue based on the priority of the workload. In some embodiments, the workload is inserted into the task queue based on the priority of the workload and time slices for workloads in the task queue. At 606, the workload at the queue head of the task queue is removed. For example, in some embodiments, a workload is removed from the queue head of each task queue in a plurality of task queues in turn, the removed workload may be processed, and remaining workloads in the task queue wait for processing.

At 608, a priority threshold is acquired from a machine learning model. For example, queue data information of the task queue, including but not limited to task queue length, workload priority distribution, workload group size, and response time distribution, may be transmitted to the machine learning model. The machine learning model calculates the current priority threshold based on the queue data information. It is understandable that when the queue data information changes, the calculated priority threshold may also change. At 610, the priority of the workload removed from the task queue is compared with the priority threshold. For example, in some embodiments, the priority of the workload removed from the task queue may be 3, and the priority threshold may be 4. If the priority of the removed workload is less than the priority threshold, the procedure proceeds to 614 to process the workload without using the processor, for saving processor resources for processing other high-priority workloads. In addition, in some embodiments, the priority of the workload removed from the task queue may be 3, the priority threshold may be 2, and therefore, the procedure proceeds to 612 to process the workload by utilizing the processor. It is understandable that due to changes in the processor resources, the priority threshold may also dynamically change, and the processing method of workloads having the same priority may also change to ensure that the processor is used to process high-priority workloads when the processor resources are insufficient, and the processor may also be used to process low-priority workloads when the processor resources are sufficient, thereby improving the processing efficiency of the system.

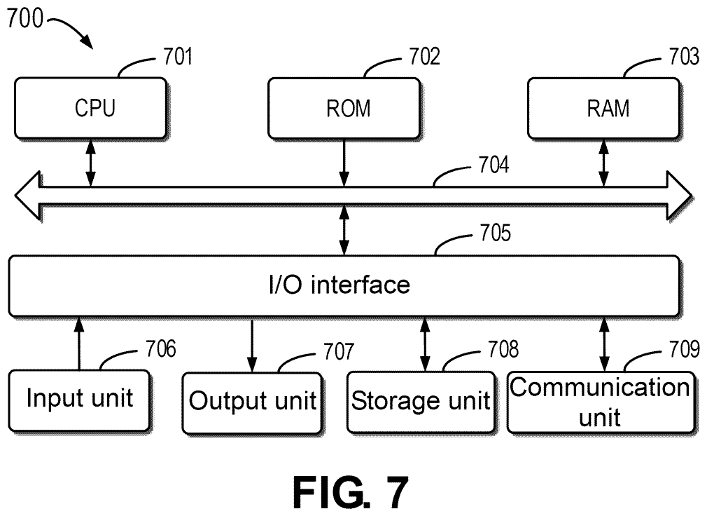

FIG. 7 shows a schematic block diagram of a device 700 that can be used to implement an embodiment of the present disclosure. The device 700 may be the device or apparatus described in the embodiments of the present disclosure. As shown in FIG. 7, the device 700 includes a central processing unit (processor) 701 that may perform various appropriate actions and processing according to computer program instructions stored in a read-only memory (ROM) 702 or computer program instructions loaded from a storage unit 708 to a random access memory (RAM) 703. Various programs and data required for the operation of the device 700 may also be stored in the RAM 703. The processor 701, the ROM 702, and the RAM 703 are connected to each other via a bus 704. An Input/Output (I/O) interface 705 is also connected to the bus 704.

A plurality of components in the device 700 are connected to the I/O interface 705, including: an input unit 706, such as a keyboard and a mouse; an output unit 707, such as various types of displays and speakers; a storage unit 708, such as a magnetic disk and an optical disc; and a communication unit 709, such as a network card, a modem, and a wireless communication transceiver. The communication unit 709 allows the device 700 to exchange information/data with other devices via a computer network, such as the Internet, and/or various telecommunication networks.

The various methods or processes described above may be performed by the processing unit 701. For example, in some embodiments, the method may be implemented as a computer software program that is tangibly included in a machine-readable medium, such as the storage unit 708. In some embodiments, part or all of the computer program may be loaded and/or installed onto the device 700 via the ROM 702 and/or the communication unit 709. When the computer program is loaded into the RAM 703 and executed by the processor 701, one or more steps or actions of the methods or processes described above may be performed.

In some embodiments, the methods and processes described above may be implemented as a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

These computer-readable program instructions can be provided to a processing unit of a general-purpose computer, a special-purpose computer, or another programmable data processing apparatus to produce a machine, such that these instructions, when executed by the processing unit of the computer or another programmable data processing apparatus, generate an apparatus for implementing the functions/actions specified in one or more blocks in the flow charts and/or block diagrams. The computer-readable program instructions may also be stored in a computer-readable storage medium. These instructions cause a computer, a programmable data processing apparatus, and/or another device to operate in a particular manner, such that the computer-readable medium storing the instructions includes an article of manufacture which includes instructions for implementing various aspects of the functions/actions specified in one or more blocks in the flow charts and/or block diagrams.

The computer-readable program instructions can be loaded onto a computer, other programmable data processing apparatuses, or other devices, so that a series of operating steps are performed on the computer, other programmable data processing apparatuses, or other devices to produce a computer-implemented process. Therefore, the instructions executed on the computer, other programmable data processing apparatuses, or other devices implement the functions/actions specified in one or more blocks in the flow charts and/or block diagrams.

The flow charts and block diagrams in the accompanying drawings show the architectures, functions, and operations of possible implementations of the device, the method, and the computer program product according to a plurality of embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, the functions denoted in the blocks may also occur in a sequence different from that shown in the figures. For example, two consecutive blocks may in fact be executed substantially concurrently, and sometimes they may also be executed in a reverse order, depending on the functions involved. It should be further noted that each block in the block diagrams and/or flow charts as well as a combination of blocks in the block diagrams and/or flow charts may be implemented by a dedicated hardware-based system executing specified functions or actions, or by a combination of dedicated hardware and computer instructions.

The embodiments of the present disclosure have been described above. The above description is illustrative, rather than exhaustive, and is not limited to the disclosed various embodiments. Numerous modifications and alterations are apparent to persons of ordinary skill in the art without departing from the scope and spirit of the illustrated embodiments. The selection of terms as used herein is intended to best explain the principles and practical applications of the various embodiments or the technical improvements to technologies on the market, or to enable other persons of ordinary skill in the art to understand the embodiments disclosed here.

1. A method for allocating workloads, comprising:
determining a priority threshold for a task queue based on queue data of the task queue;
acquiring a priority of a workload at a queue head of the task queue;
processing the workload by using a processor in response to the priority being greater than the priority threshold; and
processing the workload without using the processor in response to the priority being less than or equal to the priority threshold.

2. The method according to claim 1, further comprising:
selecting the task queue from a plurality of task queues;
acquiring the priority of each workload in the task queue; and
inserting, based on the priority of the workload to be inserted and the priority of each workload in the task queue, the workload to be inserted into the task queue.

3. The method according to claim 2, further comprising:
moving the workload to the queue head of the task queue in response to a time slice for the workload being less than a time slice threshold.

4. The method according to claim 3, further comprising:
inserting, based on the priority of the workload to be inserted and the priority and the time slice for each workload in the task queue, the workload into the task queue.

5. The method according to claim 1, wherein the priority threshold is determined by utilizing a machine learning model, comprising:
acquiring the queue data of the task queue, wherein the queue data comprises at least one of task queue length, workload priority distribution, workload group size, and response time distribution; and
determining, based on the queue data, the priority threshold by utilizing the machine learning model.

6. The method according to claim 5, further comprising:
writing the queue data into a historical database; and
regularly training the machine learning model based on historical queue data in the historical database and a labeled value of the priority threshold.

7. The method according to claim 2, wherein acquiring the priority of the workload at the queue head of the task queue comprises:
removing the workload at the queue head of the task queue; and
acquiring the priority of the removed workload.

8. The method according to claim 7, further comprising:
determining whether a time slice for the workload in each task queue of the plurality of task queues is less than a time slice threshold; and
moving, in response to the time slice for the workload in each task queue of the plurality of task queues being less than the time slice threshold, the workload to the queue head of the corresponding task queue.

9. The method according to claim 8, wherein the priority of the workload is configurable.

10. The method according to claim 2, wherein selecting the task queue from the plurality of task queues comprises selecting the task queue by utilizing a round-robin scheduling algorithm.

11. An electronic device, comprising:
a processing unit; and
a memory coupled to the processing unit and storing instructions, wherein the instructions, when executed by the processing unit, perform following actions:
determining a priority threshold for a task queue based on queue data of the task queue;
acquiring a priority of a workload at a queue head of the task queue;
processing the workload by using a processor in response to the priority being greater than the priority threshold; and
processing the workload without using the processor in response to the priority being less than or equal to the priority threshold.

12. The device according to claim 11, wherein the actions further comprise:
selecting the task queue from a plurality of task queues;
acquiring the priority of each workload in the task queue; and
inserting, based on the priority of the workload to be inserted and the priority of each workload in the task queue, the workload to be inserted into the task queue.

13. The device according to claim 12, wherein the actions further comprise:
moving the workload to the queue head of the task queue in response to a time slice for the workload being less than a time slice threshold.

14. The device according to claim 13, wherein the actions further comprise:
inserting, based on the priority of the workload to be inserted and the priority and the time slice for each workload in the task queue, the workload into the task queue.

15. The device according to claim 11, wherein the priority threshold is determined by utilizing a machine learning model, comprising:
acquiring the queue data of the task queue, wherein the queue data comprises at least one of task queue length, workload priority distribution, workload group size, and response time distribution; and
determining, based on the queue data, the priority threshold by utilizing the machine learning model.

16. The device according to claim 15, wherein the actions further comprise:
writing the queue data into a historical database; and
regularly training the machine learning model based on historical queue data in the historical database and a labeled value of the priority threshold.

17. The device according to claim 12, wherein acquiring the priority of the workload at the queue head of the task queue comprises:
removing the workload at the queue head of the task queue; and
acquiring the priority of the removed workload.

18. The device according to claim 17, wherein the actions further comprise:
determining whether a time slice for the workload in each task queue of the plurality of task queues is less than a time slice threshold; and
moving, in response to the time slice for the workload in each task queue of the plurality of task queues being less than the time slice threshold, the workload to the queue head of the corresponding task queue.

19. The device according to claim 18, wherein the priority of the workload is configurable.

20. A computer program product, wherein the computer program product is tangibly stored on a non-volatile computer-readable medium and comprises machine-executable instructions, and the machine-executable instructions, when executed, cause a machine to perform following actions:
determining a priority threshold for a task queue based on queue data of the task queue;
acquiring a priority of a workload at a queue head of the task queue;
processing the workload by using a processor in response to the priority being greater than the priority threshold; and
processing the workload without using the processor in response to the priority being less than or equal to the priority threshold.
